(19) United States
(12) Patent Application Publication
(10) Pub. No.: US 2025/0391620 A1
(43) Pub. Date: Dec. 25, 2025

(54) PRESSING OPERATION UNIT AND SWITCHING DEVICE

(71) Applicant: ALPS ALPINE CO., LTD., Tokyo (JP)

(72) Inventors: Hideyuki ISHIDA, Miyagi (JP); Hiroshi OHARA, Miyagi (JP); Kazutaka ISE, Jiangsu (CN); Katsutoshi USUI, Miyagi (JP); Tomoyuki HIGUCHI, Miyagi (JP)

(21) Appl. No.: 19/317,542

(22) Filed: Sep. 3, 2025

Related U.S. Application Data
(63) Continuation of application No. PCT/JP2024/007494, filed on Feb. 29, 2024.

(30) Foreign Application Priority Data
Mar. 6, 2023 (JP) 2023-033935

(51) Int. Cl. H01H 13/14; H01H 1/06; H01H 13/04; H01H 13/10; H01H 13/52

(52) U.S. Cl. CPC H01H 13/14; H01H 1/06; H01H 13/04; H01H 13/10; H01H 13/52

(57) ABSTRACT

A pressing operation unit includes: an operating member configured to receive a pressing operation from an operator; a leaf spring member configured to elastically deform to provide an operating sensation in response to the pressing operation; and a housing configured to retain the plate spring member, wherein the operating member includes: an insulator configured to cover the housing, a first projection provided on one surface of the insulator, and a second projection that is provided on another surface of the insulator and at a position to face the first projection, and wherein a material of the first projection is different from a material of the second projection.

### CROSS-REFERENCE TO RELATED APPLICATIONS

This application is a continuation application of International Application No. PCT/JP2024/007494, filed on Feb. 29, 2024, and designated the U.S., which is based upon and claims priority to Japanese Patent Application No. 2023-033935, filed on Mar. 6, 2023, the entire contents of which are incorporated herein by reference.

### BACKGROUND OF THE INVENTION

### 1. Field of the Invention The present disclosure relates to a pressing operation unit and a switching device.

### 2. Description of the Related Art

Japanese Patent Application Publication No. 2011-100549 discloses a push switch configured to perform a switching operation while providing a tactile click sensation in response to a pressing operation. This is achieved by elastically deforming a movable contact spring through the pressing operation on a projection formed of a hard resin material.

### SUMMARY OF THE INVENTION

However, in push switches of the related art, when a soft material is used for the projection receiving the pressing operation in order to achieve an overtravel operation by utilizing elastic deformation of the projection, there is a concern that undesirable wear may easily occur on the projection. Accordingly, input devices of the related art have not been able to simultaneously achieve both enhanced durability of the projection receiving a pressing operation and the realization of the overtravel operation.

A pressing operation unit according to one embodiment includes: an operating member configured to receive a pressing operation from an operator; a leaf spring member configured to elastically deform in response to the pressing operation, to provide an operating sensation; and a housing configured to retain the leaf spring member, wherein the operating member includes: an insulator configured to cover the housing, a first projection provided on one surface of the insulator, and a second projection that is provided on another surface of the insulator and at a position to face the first projection, and wherein a material of the first projection is different from a material of the second projection.

### BRIEF DESCRIPTION OF THE DRAWINGS

FIG. 1 is an external perspective view of a switching device according to a first embodiment;

FIG. 2 is an exploded perspective view of the switching device according to the first embodiment;

FIG. 3 is a cross-sectional view of the switching device according to the first embodiment, taken along the YZ plane;

FIG. 4 is an exploded perspective view of an operating member of the switching device according to the first embodiment;

FIG. 5A and FIG. 5B are views illustrating a method of manufacturing the operating member of the switching device according to the first embodiment;

FIG. 6 is a view illustrating a first modification of the operating member of the switching device according to the first embodiment;

FIG. 7 is a view illustrating a second modification of the operating member of the switching device according to the second embodiment;

FIG. 8 is a view illustrating a third modification of the operating member of the switching device according to the first embodiment;

FIG. 9 is a view illustrating a fourth modification of the operating member of the switching device according to the first embodiment;

FIG. 10 is an external perspective view of a pressing operation unit according to a second embodiment;

FIG. 11 is an exploded perspective view of the pressing operation unit according to the second embodiment; and

FIG. 12 is a cross-sectional view of the pressing operation unit according to the second embodiment, taken along the YZ plane.

### DESCRIPTION OF THE EMBODIMENTS

Hereinafter, embodiments will be described with reference to the drawings. In the following description, for convenience, the Z-axis, Y-axis, and X-axis directions in the drawings correspond to the up-down, right-left, and front-rear directions, respectively. Note that the positive Z-axis, positive Y-axis, and positive X-axis directions correspond to the upward, rightward, and forward directions, respectively.

### First Embodiment

### (Overview of Switching Device 100)

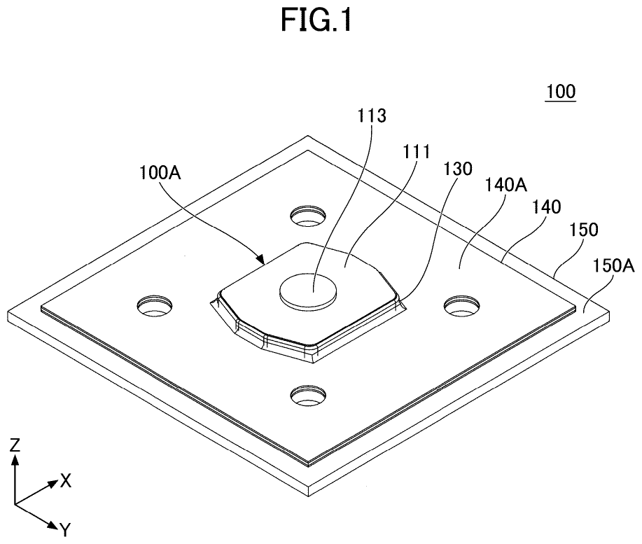

FIG. 1 is an external perspective view of a switching device 100 according to a first embodiment. As illustrated in FIG. 1, the switching device 100 has an overall thin profile in the up-down direction (the Z-axis direction).

As illustrated in FIG. 1, the switching device 100 is constituted such that a membrane sheet 140 is attached to an upper surface 150A of a plate 150, and a pressing operation unit 100A is placed on and fixed to an upper surface 140A of the membrane sheet 140.

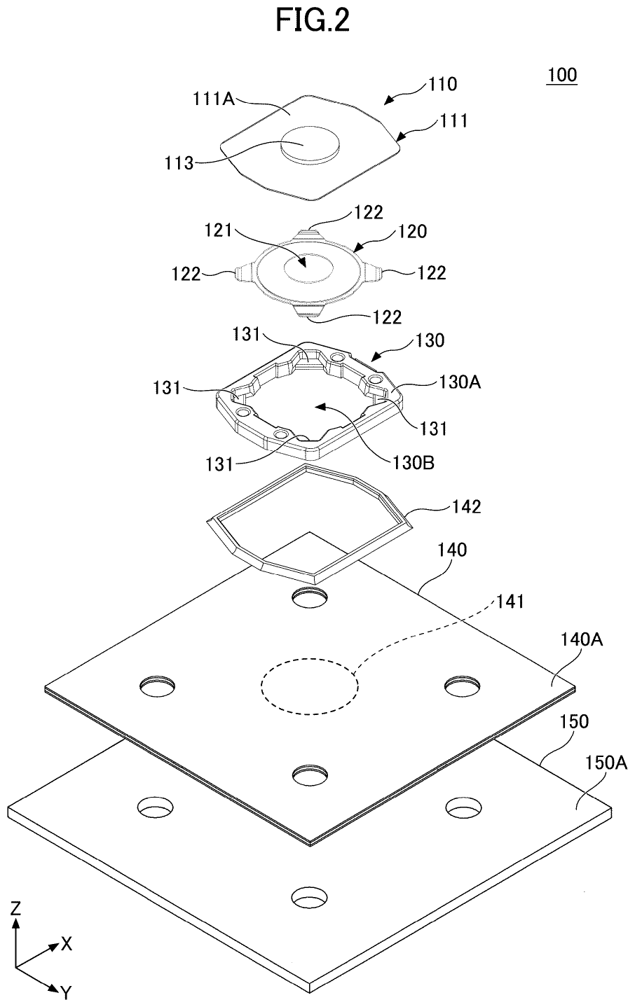

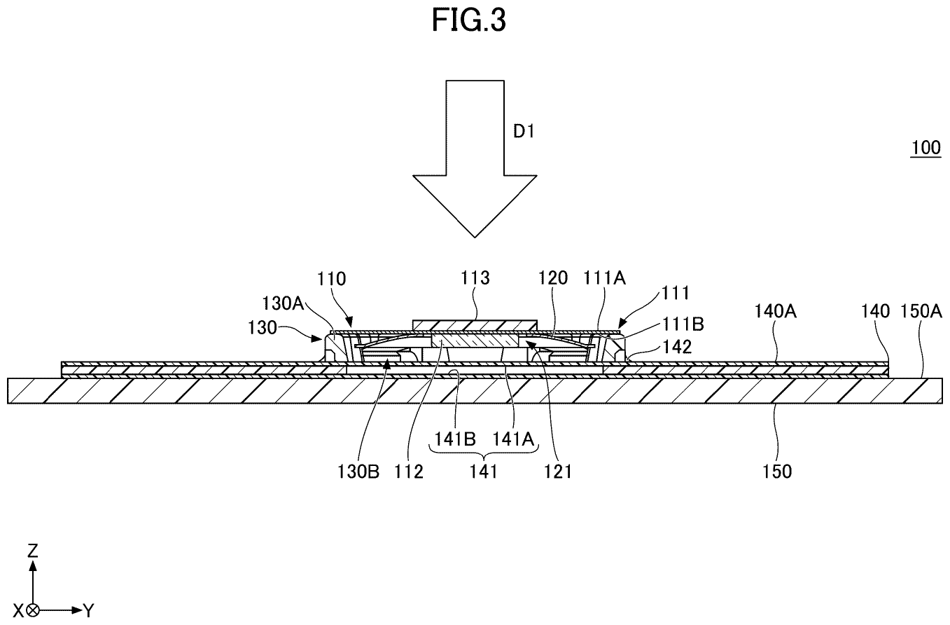

In the pressing operation unit 100A, an upper surface 130A (see FIGS. 2 and 3) of a thin flat housing 130 is covered with a sheet-like insulator 111. A second projection 113 bulging upward (the positive Z-axis direction) is provided at a central portion of the upper surface of the insulator 111. Thus, the switching device 100 enables a downward (the negative Z-axis direction) pressing operation on the second projection 113 performed by an operator.

When an operator does not perform a pressing operation on the second projection 113 of the switching device 100, a membrane switch 141 (see FIGS. 2 and 3) provided on the membrane sheet 140 is turned off. When an operator performs a downward (negative Z-axis direction) pressing operation on the second projection 113 of the switching device 100, the membrane switch 141 is turned on.

### (Configuration of Switching Device 100)

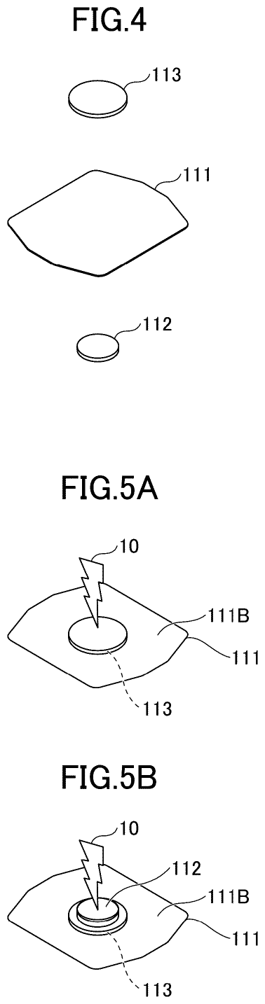

FIG. 2 is an exploded perspective view of the switching device 100 according to the first embodiment. FIG. 3 is a cross-sectional view of the switching device 100 according to the first embodiment, taken along the YZ plane. FIG. 4 is an exploded perspective view of an operating member 110 of the switching device 100 according to the first embodiment. As illustrated in FIGS. 2 and 3, the switching device 100 includes the pressing operation unit 100A, the membrane sheet 140, and the plate 150.

The pressing operation unit 100A includes the operating member 110, a metal contact 120, and the housing 130.

The operating member 110 enables a pressing operation performed by an operator in the pressing operation direction D1 (negative Z-axis direction). The operating member 110 includes an insulator 111, a first projection 112, and the second projection 113.

The insulator 111 is a thin, sheet-like member attached to the upper surface 130A of the housing 130. A resin material, such as polyethylene terephthalate (PET) or the like, is used to form the insulator 111. The insulator 111 has a shape (i.e., substantially square) that conforms to the outer shape of the housing 130 in plan view from above (positive Z-axis direction). The insulator 111 is bonded to the upper surface 130A of the housing 130 by a desired bonding means (e.g., laser welding or the like) while covering the upper surface 130A of the housing 130. The insulator 111 encloses an opening 130B of the housing 130 by closing an upper opening of the opening 130B.

The first projection 112 is provided at the center of a rear surface 111B (surface toward a leaf spring member) of the insulator 111. The first projection 112 is welded to the rear surface 111B of the insulator 111 by laser welding. The first projection 112 is thin in the vertical direction (Z-axis direction) and has a cylindrical shape. A resin material is used to form the first projection 112.

The first projection 112 has a smaller diameter than the second projection 113. Moreover, the first projection 112 has a smaller diameter than the opening 121 of the metal contact 120 and is disposed through the opening 121 of the metal contact 120.

The second projection 113 is provided at the center (i.e., a position to face the first projection 112) of the front surface 111A (surface toward an operator) of the insulator 111. The second projection 113 is welded to the front surface 111A of the insulator 111 by laser welding. The second projection 113 is thin in the vertical direction (Z-axis direction) and has a cylindrical shape. A resin material is used to form the second projection 113.

A material of the second projection 113 is different from a material of the first projection 112. In particular, the material of the second projection 113 is harder than the material of the first projection 112. Furthermore, a diameter of the second projection 113 is larger than a diameter of the opening 121 of the metal contact 120.

The metal contact 120 is an example of a “leaf spring member.” The metal contact 120 is disposed under (toward the negative Z-axis direction) the operating member 110 and in the opening 130B of the housing 130. The metal contact 120 is a metal dome-shaped member bulging upward (positive Z-axis direction). The metal contact 120 has a circular shape in plan view from above (positive Z-axis direction). One or a plurality of thin metal plates are used to form the metal contact 120. The metal contact 120 has a circular opening 121 in the center.

The metal contact 120 has four legs 122 extending outward and downward from the outer peripheral edge of the metal contact 120. The metal contact 120 is supported by the housing 130 through the four legs 122, each connected to its corresponding supporting surface 131 of four supporting surfaces 131 provided at the housing 130.

When a pressing operation is performed on the operating member 110 in the pressing operation direction

D1 (negative Z-axis direction), the central portion of the metal contact 120 at which the opening 121 is formed is pressed downward by the operating member 110. When the predetermined operating load is exceeded, the central portion is rapidly elastically deformed into a recessed shape (inversion motion). This enables the metal contact 120 to provide the operator of the operating member 110 with an operating sensation (tactile click sensation). When the pressing force is no longer applied from the operating member 110, the central portion of the metal contact 120 recovers into the original bulging shape by the elastic force.

The housing 130 is a thin flat member with a thin profile in the up-down direction (Z-axis direction). The housing 130 has a substantially square shape in plan view from above (positive Z-axis direction). The housing 130 has the upper surface 130A and the opening 130B penetrating through the housing 130 in the up-down direction. The metal contact 120 is disposed in the opening 130B. The opening 130B has substantially the same shape as the outer shape of the metal contact 120 in plan view from above (positive Z-axis direction). A relatively hard insulating material (e.g., a hard resin or the like) is used to form the housing 130.

The housing 130 has the four supporting surfaces 131 formed so as to project outward in the radial direction from the opening 130B. Each of the four supporting surfaces 131 has a horizontally flat shape. Each of the four supporting surfaces 131 supports its corresponding leg 122 of the four legs 122 of the metal contact 120.

The membrane sheet 140 is a sheet-like member formed of a flexible resin. The pressing operation unit 100A is placed on the upper surface 140A of the membrane sheet 140 with the center of the membrane sheet 140 aligned with the center of the pressing operation unit 100A. The pressing operation unit 100A is fixed to the upper surface 140A of the membrane sheet 140 along the outer periphery of the housing 130 by an adhesive 142 on the upper surface 140A of the membrane sheet 140.

The membrane switch 141 is provided at the central portion of the membrane sheet 140. The membrane switch 141 is constituted by including an upper contact 141A and a lower contact 141B, which are both thin conductive films disposed opposite to each other in the up-down direction (Z-axis direction). When a pressing operation is performed on the operating member 110 in the pressing operation direction D1 (negative Z-axis direction), the membrane switch 141 is pressed by the first projection 112 of the operating member 110, and the upper contact 141A and the lower contact 141B come into contact with each other, thereby turning on the membrane switch 141.

The plate 150 is a flat member formed of a relatively hard resin. The membrane sheet 140 is attached to the upper surface 150A of the plate 150 by an adhesive member and/or agent (e.g., a double-sided sheet, an adhesive, or the like) so that the plate 150 supports the membrane sheet 140 in a horizontal state. A relatively hard insulating material (e.g., a hard resin, or the like) is used to form the plate 150.

### (Operation of Switching Device 100)

In the switching device 100 according to the first embodiment, as illustrated in FIGS. 1 to 3, when the second projection 113 of the operating member 110 is not pressed by an operator, the insulator 111 of the operating member 110 is in a horizontal state, and the metal contact 120 is in a dome shape bulging upward (the positive Z-axis direction). The membrane switch 141 is in a state of being turned off since the upper contact 141A and the lower contact 141B are separated from each other.

In the switching device 100 according to the first embodiment, when the second projection 113 of the operating member 110 is pressed in the pressing operation direction D1 (negative Z-axis direction) by an operator, the central portion of the insulator 111 of the operating member 110 is deformed downward (negative Z-axis direction), and the first projection 112 of the operating member 110 is moved downward (negative Z-axis direction) together with the second projection 113. At this time, the second projection 113 presses the central portion of the metal contact 120 (the portion at the periphery of the opening 121) through the insulator 111. Therefore, the central portion of the metal contact 120 is gradually elastically deformed downward (negative Z-axis direction), and the operating load of the pressing operation of the operating member 110 gradually increases accordingly.

Furthermore, when a stroke distance for the pressing operation of the operating member 110 reaches a predetermined value, the central portion of the metal contact 120 suddenly undergoes elastic deformation into a recessed shape (inverse motion). As a result, the operating load of the pressing operation of the operating member 110 suddenly decreases. This provides an operating sensation (tactile click sensation) to the operator of the operating member 110.

The first projection 112 presses the membrane switch 141 at the same time as the inversion motion of the metal contact 120. Accordingly, the membrane switch 141 is turned on by bringing the upper contact 141A and the lower contact 141B into contact with each other.

In a case in which the operator further pushes in the second projection 113 in the pressing operation direction D1 (the negative Z-direction) even after the membrane switch 141 has been turned on (i.e., when a so-called overtravel operation is performed), the first projection 112 is elastically deformed so that the second projection 113 can move slightly downward.

When the operator no longer presses the second projection 113 thereafter, the metal contact 120 returns to its original bulging shape by its own elastic force. Accordingly, the insulator 111 returns to its initial horizontal state. Also, the upper contact 141A and the lower contact 141B are no longer in contact with each other, and the membrane switch 141 is turned off again, returning to its original state.

As described above, at the operating member 110 of the pressing operation unit 100A according to the first embodiment, the first projection 112 is provided on the rear surface 111B of the insulator 111, and the second projection 113 is provided on the front surface 111A of the insulator 111.

Thus, the pressing operation unit 100A according to the first embodiment can press the membrane switch 141 with the first projection 112 when the second projection 113 receives a pressing operation in the pressing operation direction D1 (in the negative Z-axis direction) by an operator.

Herein, in the pressing operation unit 100A according to the first embodiment, a material of the second projection 113 is different from a material of the first projection 112. In particular, the material of the second projection 113 is harder than the material of the first projection 112.

Thus, in the pressing operation unit 100A according to the first embodiment, the second projection 113 is relatively hard. This can lead to less occurrence of wear and the like of the second projection 113 and enable a direct application of a pressing operation force on the operating member 110 (i.e., with substantially no attenuation) from the second projection 113.

In addition, in the pressing operation unit 100A according to the first embodiment, the first projection 112 is relatively soft. This can achieve the overtravel operation through moderate elastic deformation of the first projection 112 when an operator performs the overtravel operation.

Therefore, according to the pressing operation unit 100A of the first embodiment, it is possible to enhance the durability of the second projection 113 receiving the pressing operation and achieve the overtravel operation.

In the pressing operation unit 100A according to the first embodiment, the first projection 112 has a smaller diameter than the second projection 113. The first projection 112 has a smaller diameter than the opening 121 of the metal contact 120 and penetrates the opening 121 of the metal contact 120, and the second projection 113 has a larger diameter than the opening 121 of the metal contact 120.

Thus, in the pressing operation unit 100A according to the first embodiment, the second projection 113 can press the portion of the metal contact 120 at the periphery of the opening 121 of the metal contact 120 through the insulator 111 without interference of the first projection 112 with the metal contact 120 during the pressing operation.

In the present embodiment, for example, the first projection 112, the second projection 113, and the opening 121 of the metal contact 120 have diameters of 1.7 mm, 2.4 mm, and 2.0 mm, respectively.

### (Method of Manufacturing Operating Member 110)

FIGS. 5A and 5B are views illustrating a method of manufacturing the operating member 110 of the switching device 100 according to the first embodiment.

First, as illustrated in FIG. 5A, in a state where the second projection 113 is disposed at the central portion of the front surface 111A of the insulator 111, a laser 10 is emitted to the central portion of the rear surface 111B of the insulator 111 (a first laser emitting step).

Herein, in the present embodiment, a transparent resin material is used to form the insulator 111. Moreover, in the present embodiment, a colored and opaque resin material, particularly a black resin material, is used to form the second projection 113.

Therefore, the laser 10 emitted to the central portion of the rear surface 111B of the insulator 111 penetrates the insulator 111 and is emitted to the second projection 113. Thus, the second projection 113 absorbs heat from the laser 10 and melts the insulator 111 so that the second projection 113 is welded to the insulator 111.

Next, as illustrated in FIG. 5B, the laser 10 is emitted to the first projection 112 in a state where the first projection 112 is disposed at the central portion of the rear surface 111B of the insulator 111 (a second laser emitting step).

Herein, in the present embodiment, a transparent resin material is used to form the first projection 112.

Therefore, the laser 10 emitted to the first projection 112 penetrates the first projection 112 and the insulator 111 and is emitted to the second projection 113. Thus, the second projection 113 absorbs heat from the laser 10 and melts the insulator 111 so that the second projection 113 and the first projection 112 are welded to the insulator 111.

As described above, in the operating member 110 according to the first embodiment, the first projection 112, the second projection 113, and the insulator 111 are formed of a transparent material, a colored and opaque material, and a transparent material, respectively.

Thus, the operating member 110 according to the first embodiment can weld the first projection 112 and the second projection 113 to the insulator 111 by emitting the laser 10 from a single direction (from the direction of the rear surface 111B of the insulator 111).

Therefore, the operating member 110 according to the first embodiment can easily and firmly fix the first projection 112 and the second projection 113 to the insulator 111.

It is preferable that a material that forms the second projection 113 is a material having a melting point higher than a melting point of the first projection 112 in order to more securely weld the first projection 112 through the heat absorption by the second projection 113.

### (First Modification of Operating Member 110)

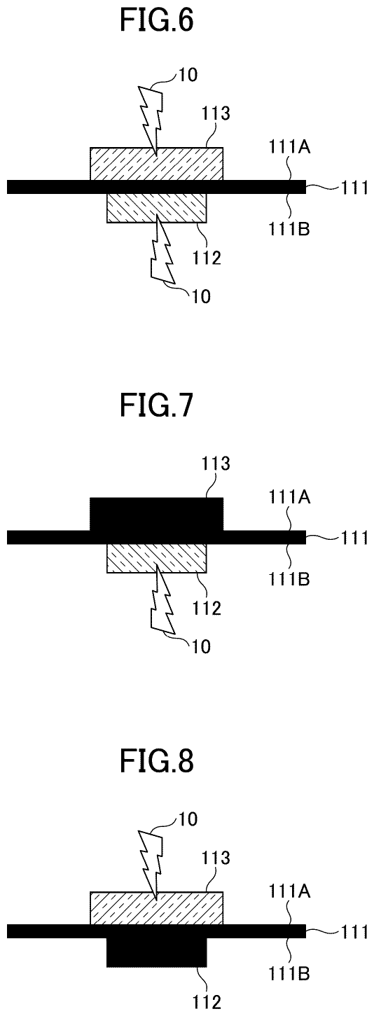

FIG. 6 is a view illustrating a first modification of the operating member 110 of the switching device 100 according to the first embodiment.

In the operating member 110 illustrated in FIG. 6, the first projection 112, the second projection 113, and the insulator 111 are formed of a transparent material, a transparent material, and a colored and opaque material, respectively.

In this case, as illustrated in FIG. 6, the first projection 112 and the second projection 113 can be welded to the insulator 111 by emitting the laser 10 from the direction of the front surface 111A of the insulator 111 or from the direction of the rear surface 111B of the insulator 111.

### (Second Modification of Operating Member 110)

FIG. 7 is a view illustrating a second modification of the operating member 110 of the switching device 100 according to the first embodiment.

In the operating member 110 illustrated in FIG. 7, the first projection 112, the second projection 113, and the insulator 111 are formed of a transparent material, a colored and opaque material, and a colored and opaque material, respectively.

In this case, as illustrated in FIG. 7, the first projection 112 and the second projection 113 can be welded to the insulator 111 by emitting the laser 10 from the direction of the rear surface 111B of the insulator 111.

### (Third Modification of Operating Member 110)

FIG. 8 is a view illustrating a third modification of the operating member 110 of the switching device 100 according to the first embodiment.

In the operating member 110 illustrated in FIG. 8, the first projection 112, the second projection 113, and the insulator 111 are formed of a colored and opaque material, a transparent material, and a colored and opaque material, respectively.

In this case, as illustrated in FIG. 8, the first projection 112 and the second projection 113 can be welded to the insulator 111 by emitting the laser 10 from the direction of the front surface 111A of the insulator 111.

### (Fourth Modification of Operating Member 110)

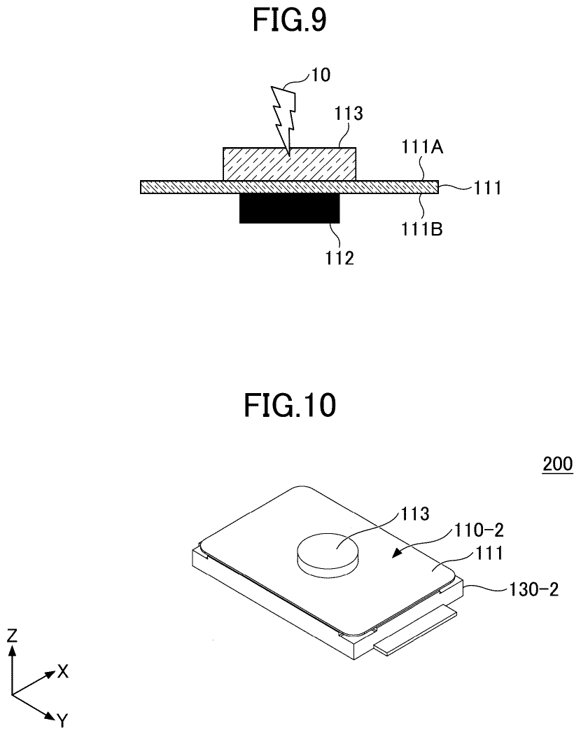

FIG. 9 is a view illustrating a fourth modification of the operating member 110 of the switching device 100 according to the first embodiment.

In the operating member 110 illustrated in FIG. 9, the first projection 112, the second projection 113, and the insulator 111 are formed of a colored and opaque material, a transparent material, and a transparent material, respectively.

In this case, as illustrated in FIG. 9, the first projection 112 and the second projection 113 can be welded to the insulator 111 by emitting the laser 10 from the direction of the front surface 111A of the insulator 111.

### Second Embodiment

### (Configuration of Pressing Operation Unit 200)

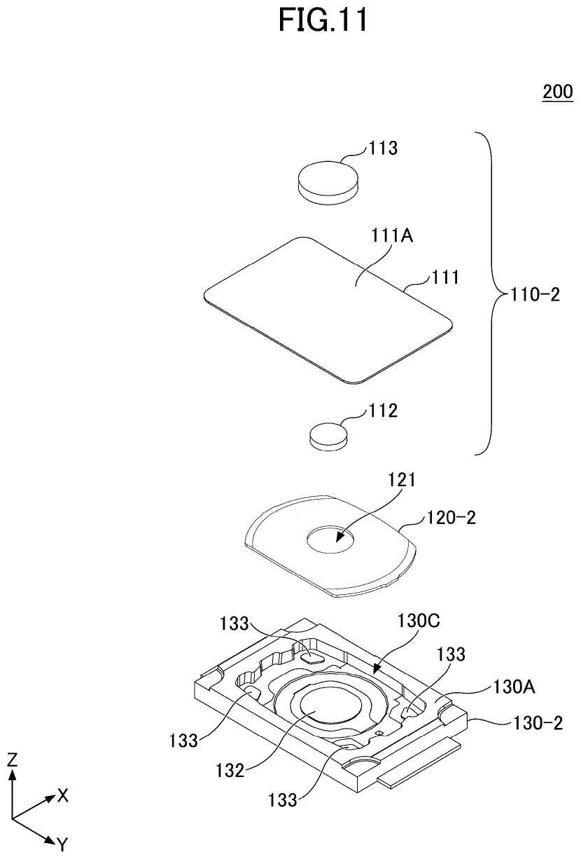

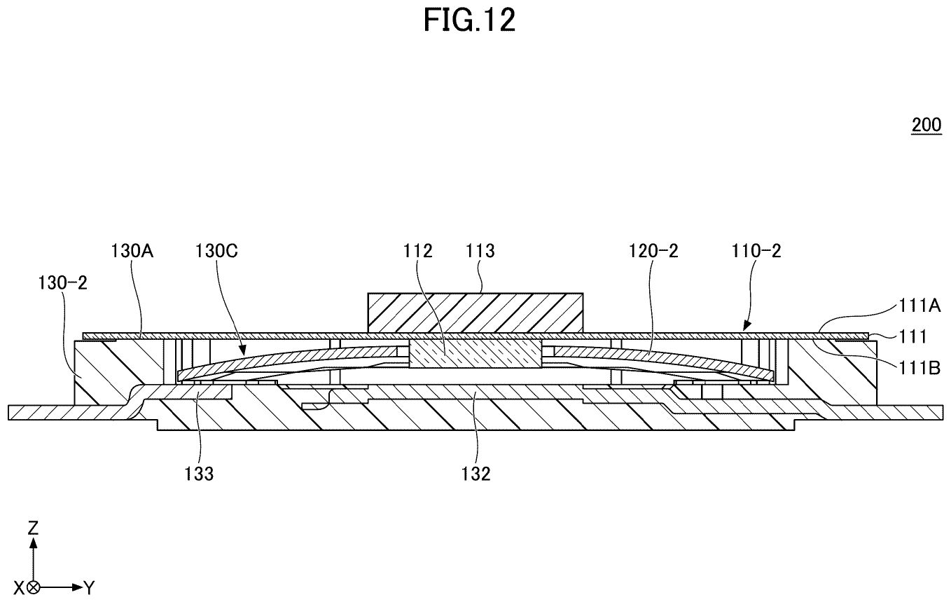

FIG. 10 is an external perspective view of a pressing operation unit 200 according to a second embodiment. FIG. 11 is an exploded perspective view of the pressing operation unit 200 according to the second embodiment. FIG. 12 is a cross-sectional view of the pressing operation unit 200 according to the second embodiment, taken along a YZ plane.

The pressing operation unit 200 according to the second embodiment functions as an independent switching device. That is, the pressing operation unit 200 is turned off when the operator does not perform a pressing operation on the second projection 113. The pressing operation unit 200 is turned on when the operator performs a downward (the negative Z-axis direction) pressing operation on the second projection 113.

As illustrated in FIGS. 10 to 12, the pressing operation unit 200 according to the second embodiment includes an operating member 110-2, a metal contact 120-2, and a housing 130-2.

The operating member 110-2 is similar to the operating member 110 of the pressing operation unit 100A according to the first embodiment. That is, similar to the operating member 110, the operating member 110-2 includes an insulator 111, a first projection 112, and a second projection 113. However, the operating member 110-2 is different from the operating member 110 in that the insulator 111 has a rectangular shape with the right-left direction (Y-axis direction) serving as the longitudinal direction in plan view from above (positive Z-axis direction).

The metal contact 120-2 is similar to the metal contact 120 of the pressing operation unit 100A according to the first embodiment. That is, the metal contact 120-2 is a dome-shaped metal member bulging upward (positive Z-axis direction). However, the metal contact 120-2 is different from the metal contact 120 in that the metal contact 120-2 has a shape, in which parts of the circle (the front end and the rear end) are cut off along straight lines parallel to the Y-axis in plan view from above (positive Z-axis direction), and does not include the four legs 122.

The metal contact 120-2 is disposed in a recess 130C of a housing 130-2. The metal contact 120-2 lands on four peripheral stationary contacts 133 and is supported by the housing 130-2. The four peripheral stationary contacts 133 are provided on the bottom surface of the recess 130C of the housing 130-2 at the right (the direction of the positive Y-axis) edge and the left (the direction of the negative Y-axis) edge.

When a pressing operation is performed on the operating member 110-2 and the central portion of the metal contact 120-2 is elastically deformed (inverse motion) into a recessed shape, the central portion of the metal contact 120-2 contacts a central stationary contact 132 of the housing 130-2, thereby electrically connecting the central stationary contact 132 and the four peripheral stationary contacts 133 via the metal contact 120-2. That is, the metal contact 120-2 functions as a “movable contact member.”

The housing 130-2 is similar to the housing 130 of the pressing operation unit 100A according to the first embodiment. However, the housing 130-2 is different from the housing 130 in that the housing 130-2 has a rectangular shape with the right-left direction (Y-axis direction) serving as the longitudinal direction in plan view from above (positive Z-axis direction).

The housing 130-2 has the recess 130C shaped by being recessed downward from an upper surface 130A, instead of having the opening 130B. The metal contact 120-2 is disposed in the recess 130C. The recess 130C has substantially the same shape as the outer shape of the metal contact 120-2 in plan view from above (positive Z-axis direction).

The housing 130-2 includes a conductive central stationary contact 132 at the central portion of the bottom surface of the recess 130C. The housing 130-2 has four conductive peripheral stationary contacts 133 at the periphery of the bottom surface of the recess 130C.

### (Operation of Pressing Operation Unit 200)

In the pressing operation unit 200 according to the second embodiment, as illustrated in FIGS. 10 to 12, when the second projection 113 of the operating member 110-2 is not pressed by an operator, the insulator 111 of the operating member 110-2 is in a horizontal state, and the metal contact 120-2 is in a dome shape bulging upward (positive Z-axis direction). The central stationary contact 132 and the four peripheral stationary contacts 133 of the housing 130-2 are not electrically connected to each other.

In the pressing operation unit 200 according to the second embodiment, when the second projection 113 of the operating member 110-2 is pressed by an operator, the central portion of the insulator 111 of the operating member 110-2 is deformed downward (negative Z-axis direction), and the first projection 112 of the operating member 110-2 is moved downward (negative Z-axis direction) together with the second projection 113. At this time, the second projection 113 presses the central portion of the metal contact 120-2 (the portion at the periphery of the opening 121) through the insulator 111. Therefore, the central portion of the metal contact 120-2 is gradually elastically deformed downward (negative Z-axis direction), and the operating load of the pressing operation of the operating member 110-2 gradually increases accordingly.

Furthermore, when the stroke distance for the pressing operation of the operating member 110-2 reaches a predetermined value, the central portion of the metal contact 120-2 suddenly undergoes elastic deformation into a recessed shape (inversion motion). As a result, the operating load of the pressing operation of the operating member 110-2 suddenly decreases. This provides an operating sensation (tactile click sensation) to the operator of the operating member 110-2.

The central portion of the metal contact 120-2 comes into contact with the central stationary contact 132 at the same time as the inversion motion of the metal contact 120. This electrically connects the central stationary contact 132 and the four peripheral stationary contacts 133 to each other.

Even after the central stationary contact 132 and the four peripheral stationary contacts 133 are electrically connected to each other, when the second projection 113 is pushed further by the operator (i.e., when the so-called overtravel operation is performed), the first projection 112 is elastically deformed so that the second projection 113 can slightly move downward.

Thereafter, when the operator no longer presses the second projection 113, the metal contact 120-2 returns to its original recessed shape by its own elastic force. In response, the insulator 111 returns to its initial horizontal state. Also, the central portion of the metal contact 120-2 and the central stationary contact 132 are no longer in contact with each other, and the central stationary contact 132 and the four peripheral stationary contacts 133 are no longer electrically connected to each other, returning to their non-conductive state.

According to one embodiment of the pressing operation unit, it is possible to enhance the durability of the projection receiving the pressing operation and the realization of the overtravel operation.

Although embodiments of the present disclosure have been described in detail above, the present disclosure is not limited to these embodiments, and various modifications or changes can be made within the scope of the gist of the present disclosure described in the claims.

What is claimed is:

1. A pressing operation unit, comprising:
an operating member configured to receive a pressing operation from an operator;
a leaf spring member configured to elastically deform in response to the pressing operation, to provide an operating sensation; and
a housing configured to retain the leaf spring member, wherein
the operating member includes
an insulator configured to cover the housing,
a first projection provided on one surface of the insulator, and
a second projection that is provided on an other surface of the insulator and at a position to face the first projection, and
wherein a material of the first projection is different from a material of the second projection.

2. The pressing operation unit according to claim 1, wherein
the first projection is provided on the one surface of the insulator toward the leaf spring member,
the second projection is provided on the other surface of the insulator toward the operator, and
the material of the second projection is harder than the material of the first projection.

3. The pressing operation unit according to claim 1, wherein
a diameter of the first projection is smaller than a diameter of the second projection.

4. The pressing operation unit according to claim 3, wherein
the leaf spring member includes an opening at a central portion of the leaf spring member,
the diameter of the first projection is smaller than a diameter of the opening of the leaf spring member, and the first projection penetrates through the opening of the leaf spring member,
the diameter of the second projection is larger than the diameter of the opening of the leaf spring member, and
the second projection presses a portion of the leaf spring member through the insulator during the pressing operation, the portion of the leaf spring member being at a periphery of the opening of the leaf spring member.

5. The pressing operation unit according to claim 1, wherein
the first projection is provided on the one surface of the insulator toward the leaf spring member, and the material of the first projection is a transparent material, and
the second projection is provided on the other surface of the insulator toward the operator, and the material of the second projection is a colored and opaque material.

6. The pressing operation unit according to claim 5, wherein
the material of the second projection is a black-colored material.

7. The pressing operation unit according to claim 5, wherein
a material of the insulator is a transparent material, and
the first projection and the second projection are welded to the insulator by emitting a laser beam from a direction of the first projection.

8. The pressing operation unit according to claim 5, wherein
the material of the second projection is a material having a melting point that is higher than a melting point of the material of the first projection.

9. A switching device, comprising:
a membrane sheet including a membrane switch; and
the pressing operation unit of claim 1, the pressing operation unit being placed on the membrane sheet and configured to press the membrane switch by the leaf spring member during the pressing operation.

10. The pressing operation unit according to claim 1, wherein
at least one of the material of the first projection, the material of the second projection, or a material of the insulator is a colored and opaque material, and
at least one of the material of the first projection or the material of the second projection is a transparent material.

11. The pressing operation unit according to claim 1, wherein
the material of the first projection is a transparent material,
the material of the second projection is a colored and opaque material, and
a material of the insulator is a transparent material.

12. The pressing operation unit according to claim 1, wherein
the material of the first projection is a transparent material,
the material of the second projection is a transparent material, and
a material of the insulator is a colored and opaque material.

13. The pressing operation unit according to claim 1, wherein
the material of the first projection is a transparent material,
the material of the second projection is a colored and opaque material, and
a material of the insulator is a colored and opaque material.

14. The pressing operation unit according to claim 1, wherein
the material of the first projection is a colored and opaque material,
the material of the second projection is a transparent material, and
a material of the insulator is a transparent material.

15. The pressing operation unit according to claim 1, wherein
the material of the first projection is a colored and opaque material,
the material of the second projection is a transparent material, and
a material of the insulator is a colored and opaque material.

16. The pressing operation unit according to claim 1, wherein
the housing includes a central stationary contact and a peripheral stationary contact, and
the leaf spring member elastically deforms to function as a movable contact member configured to electrically connect the central stationary contact and the peripheral stationary contact through the leaf spring member.
